(19) United States
(12) Patent Application Publication
(10) Pub. No.: US 2014/0189302 A1
(43) Pub. Date: Jul. 3, 2014

(54) OPTIMAL LOGICAL PROCESSOR COUNT AND TYPE SELECTION FOR A GIVEN WORKLOAD BASED ON PLATFORM THERMALS AND POWER BUDGETING CONSTRAINTS

(71) Applicant: INTEL CORPORATION, Santa Clara, CA (US)

(72) Inventors: Dheeraj R. Subbareddy, Hillsboro, OR (US); Ganapati N. Srinivasa, Portland, OR (US); David A. Koufaty, Portland, OR (US); Scott D. Hahn, Beaverton, OR (US); Mishali Naik, Santa Clara, CA (US); Paolo Narvaez, Wayland, MA (US); Abirami Prabhakaran, Hillsboro, OR (US); Eugene Gorbatov, Hillsboro, OR (US); Alon Naveh, Ramat Hasharon (IL); Inder M. Sodhi, Folsom, CA (US); Eliezer Weissmann, Haifa (IL); Paul Brett, Hillsboro, OR (US); Gaurav Khanna, Hillsboro, OR (US); Russell J. Fenger, Beaverton, OR (US)

(21) Appl. No.: 13/993,547

(22) PCT Filed: Dec. 28, 2012
(86) PCT No.: PCT/US2012/072135

§ 371 Date: Jun. 12, 2013

(51) Int. Cl. G06F 9/38

(52) U.S. Cl. CPC G06F 9/3885
USPC 712/30

(57) ABSTRACT

A processor includes multiple physical cores that support multiple logical cores of different core types, where the core types include a big core type and a small core type. A multi-threaded application includes multiple software threads are concurrently executed by a first subset of logical cores in a first time slot. Based on data gathered from monitoring the execution in the first time slot, the processor selects a second subset of logical cores for concurrent execution of the software threads in a second time slot. Each logical core in the second subset has one of the core types that matches the characteristics of one of the software threads.

### TECHNICAL FIELD

The present disclosure pertains to the field of processing logic, microprocessors, and associated instruction set architecture that, when executed by the processor or other processing logic, perform logical, mathematical, or other functional operations.

### BACKGROUND ART

Central Processing Unit (CPU) architects have endeavored to provide a consistent improvement in processor performance by increasing the number of cores in a processor. The need to scale the performance of a processor and to improve energy efficiency has resulted in the development of heterogeneous processor architecture. A heterogeneous processor includes cores with different power and performance characteristics. For example, a heterogeneous processor can integrate a mix of big cores and small cores, and thus can potentially achieve the benefits of both types of cores. Applications that demand high processing intensity can be assigned to big cores, and applications that incur low processing intensity can be assigned to small cores to save power. On mobile or other power-constrained platforms, increasing energy efficiency translates into extended battery life.

A core in a conventional heterogeneous processor is typically allocated to a processing task for its entire duration of execution. However, the processing intensity of a task may change during its execution. At any given time there may be multiple tasks being executed at the same time, and these tasks may have different and changing requirements for processing resources. Thus, static core allocation cannot optimize the utilization of processing resources and energy efficiency.

### BRIEF DESCRIPTION OF THE DRAWINGS

Embodiments are illustrated by way of example and not limitation in the Figures of the accompanying drawings:

FIG. 1 is a block diagram of a processor having a core selection module according to one embodiment.

FIG. 2 is a block diagram of a processor executing a core selection thread according to one embodiment.

FIG. 3 is a timing diagram illustrating an example of a time line for executing a core selection thread according to one embodiment.

FIG. 4 is a block diagram illustrating performance counters used by core selection according to one embodiment.

FIG. 5 illustrates execution of multi-threaded applications according to one embodiment.

FIG. 6 is a flow diagram illustrating operations to be performed according to one embodiment.

FIG. 7A is a block diagram of an in-order and out-of-order pipeline according to one embodiment.

FIG. 7B is a block diagram of an in-order and out-of-order core according to one embodiment.

FIGS. 8A-B are block diagrams of a more specific exemplary in-order core architecture according to one embodiment.

FIG. 9 is a block diagram of a processor according to one embodiment.

FIG. 10 is a block diagram of a system in accordance with one embodiment.

FIG. 11 is a block diagram of a second system in accordance with one embodiment.

FIG. 12 is a block diagram of a third system in accordance with an embodiment of the invention.

FIG. 13 is a block diagram of a system-on-a-chip (SoC) in accordance with one embodiment.

### DESCRIPTION OF THE EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description.

Embodiments described herein provide a core selection mechanism that tracks the execution of a multi-threaded application and exposes the most appropriate set of cores to the application. A multi-threaded application has multiple contexts of execution (i.e., software threads, also referred to as threads) that can be processed concurrently on multiple cores. These multiple threads may have the same instruction sequence applied on different data sets (e.g., large matrix multiplication), or may involve concurrent execution of different tasks in different threads (e.g., web-browsing and music-playing at the same time). When running a multi-threaded application, the core selection mechanism selects a subset of the cores in the processor that are most appropriate for the concurrent execution of the threads. The selection may take into account platform thermal constraints, power budgets and application scalability. In one embodiment, the core selection mechanism may be implemented by a microcontroller for out-of-band control, or a software thread for in-band control.

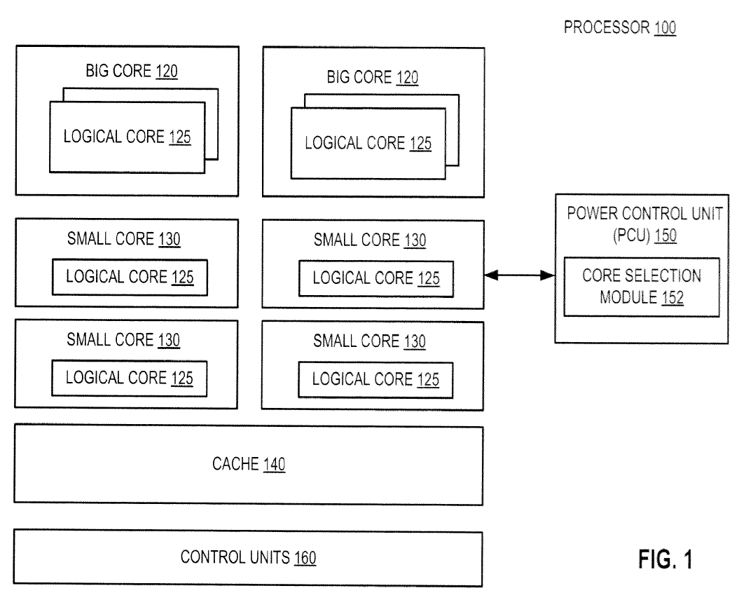

FIG. 1 is a block diagram of a processor 100 that implements a core selection mechanism according to one embodiment. In this embodiment, the processor 100 including two big cores 120 having a big core type and four small cores 130 having a small core type. It is appreciated that the processor 100 in another embodiment may include any number of big cores 120 and any number of small cores 130. In some embodiments, the processors may include more than two different core types. Each of the big cores 120 and the small cores 130 is a physical core that includes circuitry for executing instructions. Thus, in the following description the big cores 120 and the small cores 130 are collectively referred to as physical cores 120 and 130.

In one embodiment, each of the big cores 120 and the small cores 130 can support one or more logical cores 125 that are hyper-threaded to run on one physical core. Hyper-threading enables a physical core to concurrently execute multiple instructions on separate data, where the concurrent execution is supported by multiple logical cores that are assigned duplicated copies of hardware components and separate address spaces. Each logical core 125 appears to the operating system (OS) as a distinct processing unit; thus the OS can schedule two processes (i.e., two threads) for concurrent execution. The big core 120 has more processing power and consumes more power than the small core 130. Because of its higher processing power and higher power budget, the big core 120 can support more logical cores 125 than the small core 130. In the embodiment of FIG. 1, each big core 120 supports two logical cores 125 and each small core 130 supports one logical core 125. In an alternative embodiment, the number of logical cores supported by physical core 120 or 130 may be different from what is shown in FIG. 1.

The processor 100 also includes hardware circuitry outside the physical cores 120 and 130. For example, the processor 100 may include a cache 140 (e.g., a last-level cache (LLC)) shared by the physical cores 120 and 130, and control units 160 such as integrated memory controller, bus/interconnect controller, etc. It is appreciated that the processor 100 of FIG. 1 is a simplified representation and additional hardware circuitry may be included.

In one embodiment, the processor 100 is coupled to a power control unit (PCU) 150. The PCU 150 monitors and manages voltage, temperature and power consumption in the processor 110. In one embodiment, the PCU 150 is a hardware or firmware unit that is integrated with the other hardware components of the processor 110 on the same die. The PCU 150 controls the activation (e.g., turning on) and de-activation of the logical cores 125 and the physical cores 120 and 130, such as turning off the cores or putting the cores into a power saving state (e.g., a sleep state).

In an embodiment where out-of band control is implemented, the PCU 150 includes a core selection module 152, which determines a subset of the logical cores 125 for executing a multi-threaded application. In the embodiment of FIG. 1, the processor 100 supports eight logical cores 125 in total. However, due to power and thermal constraints, not all of the logical cores 125 can be active at the same time; for example, only a maximum of four logical cores 125 can be active at the same time. The multi-threaded application may run on any of the logical cores 125 in any combination (within the allowable power budget) up to the maximum number of four logical cores 125. The core selection module 152 can monitor the execution of the application to determine which logical cores 125 to use for executing the application. The core selection module 152 is aware that not all of the logical cores 125 are the same: the logical cores supported by the big cores 120 have a big core type, and the logical cores supported by the small cores 130 have a small core type. Logical cores having a big core type (also referred to as “big logical cores”) have more processing power and consume more power than logical cores having a small core type (also referred to as “small logical cores”). In addition, two logical cores concurrently running on the same big core may have less processing power and consume less energy than two logical cores concurrently running on two different big cores.

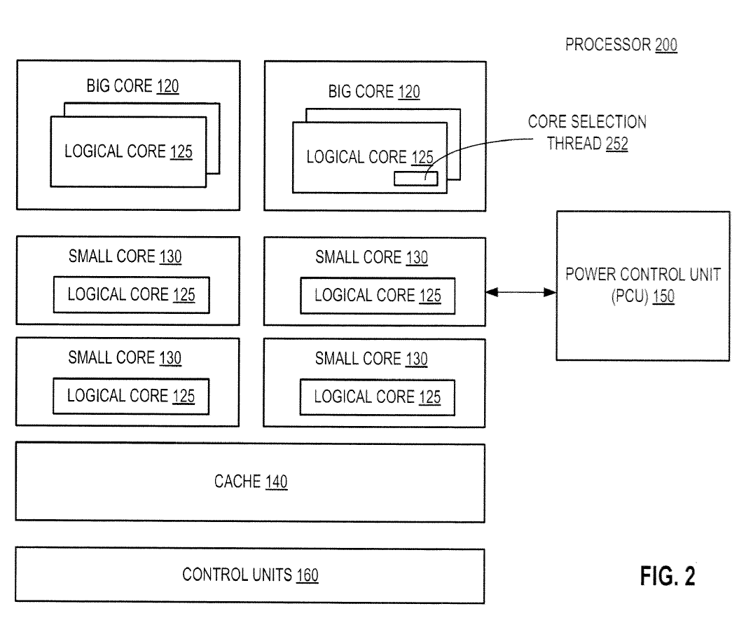

FIG. 2 is a block diagram of a processor 200 that implements a core selection mechanism according to another embodiment. The processor 200 is similar to the processor 100 of FIG. 1, except that the core selection is performed in-band by one of the physical cores executing a core selection thread 252. The core-selection thread 252 is a control thread, which can be executed by any of the logical cores 125 on any of the physical cores (i.e., any of the big cores 120 and the small cores 130). At any given time, only one core selection thread 252 is executed by the processor 100. In one embodiment, the logical core 125 (e.g., a logical core LC) that executes a multi-threaded application (or a part of the application) may also execute the core selection thread 252. If, during the execution of the application, the logical core LC is de-activated, the core selection thread 252 can be migrated to another active logical core 125 to continue the core selection operation.

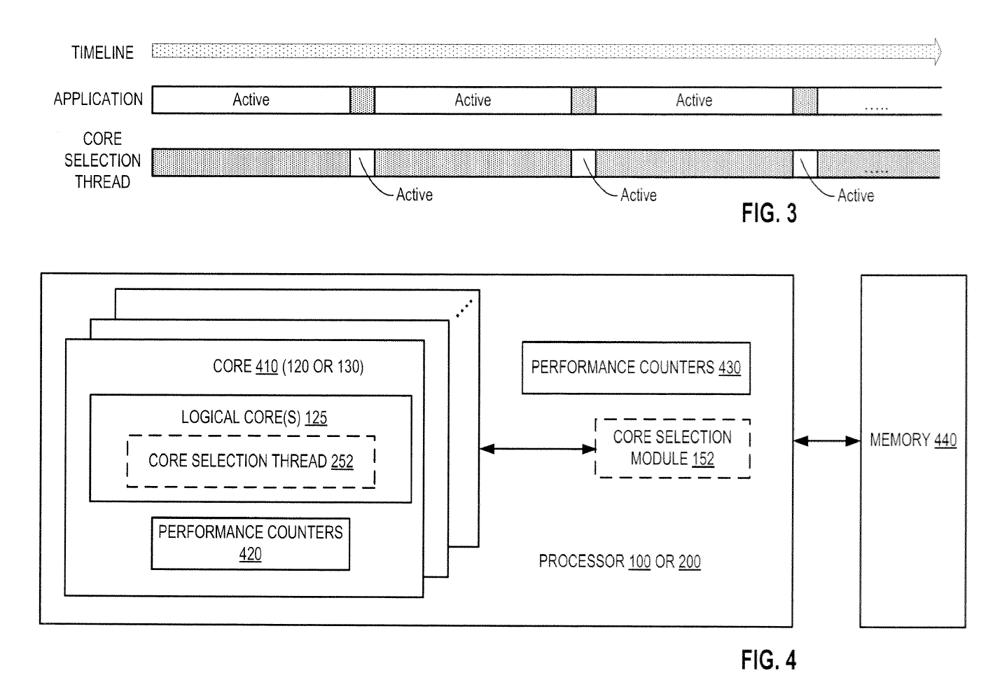

FIG. 3 is a timing diagram illustrating the logical core LC that executes the multi-threaded application and the core selection thread 252. In one embodiment, the core selection thread 252 wakes up every N milliseconds to select a subset of logical cores to execute the application. The core selection thread 252 may run only for a few microseconds. Once the subset of logical cores are selected, the logical core LC notifies the PCU 150 to activate (e.g., turn on) those selected logical cores if they are not active already. The logical cores that are not selected may be de-activated (e.g., turned off or placed in a power saving state) by the PCU 150.

In one embodiment, the selection made by the core selection mechanism (i.e., the core selection module 251 of FIG. 1 or the core selection thread 252 of FIG. 2) may be based on a number of factors, including but not limited to: the type of operation performed by the application, the availability of the cores, and the power budget. For example, if the application has four threads and the four threads are performing exactly the same operations on different sets of data, then four small logical cores may be selected to optimize the processor performance per watt. In another example, four threads may originally be assigned to four small logical cores to perform operations according to a producer-consumer model. If the core selection mechanism detects that one of the threads is a bottleneck (e.g., a computational bottleneck), the small logical core on which the bottleneck thread runs may be replaced by a big logical core to improve execution speed and to thereby improve the processor performance per watt.

In another example, if the threads are performing operations that have no time correlation between the execution instances, the core selection mechanism may assign each thread to the best available logical core in the processor, as long as the assignment is within the power budget. The best available logical core may be the core that operates at a higher power-dissipating operating point; e.g., a big logical core. If there is insufficient power budget, then a small logical core may be selected even though a big logical core is available.

In yet another example, if the core selection module mechanism detects that the application is running two threads on the same big core 120 (more specifically, on two big logical cores hyper-threaded onto the same big core 120), it may assign the two threads to two small logical cores if the aggregate performance of the two small logical cores is better than the aggregate performance of the two hyper-threaded big logical cores.

In one embodiment, the type of operation performed by the core selection may be determined based on a number of performance counters within and outside the physical cores. FIG. 4 is a block diagram illustrating an embodiment of two sets of performance counters 420 and 430, where each of the performance counters 420 is located within a physical core 410 (e.g., the small core 120 or the big core 130), and each of the performance counters 430 is outside the physical cores 410. The performance counters 420 and 430 are monitored by the core selection module 251 or the core selection thread 252 (shown in dotted boxes as two alternative embodiments) for core selection. For example, these performance counters 420 and 430 may include but are not limited to: memory load counters (which indicate how many loads from memory 440 were requested in a given period of time), LLC miss counters, second-level cache miss counters, translation lookaside buffer (TLB) miss counters, branch miss prediction counters, stall counters, etc. Any combination of these counters may be used for selecting a subset of logical cores for executing a multi-threaded application.

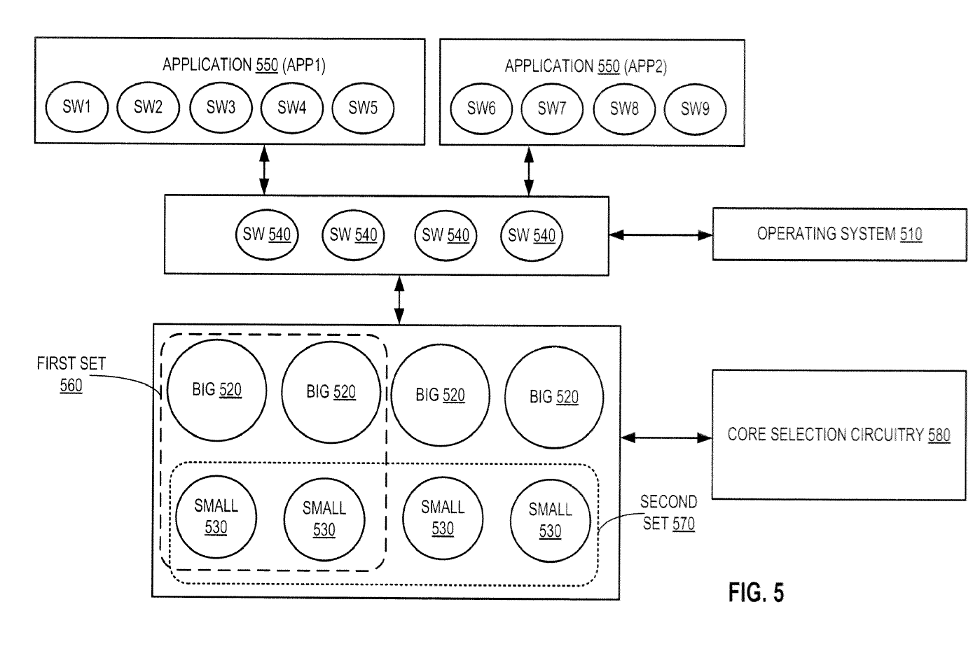

FIG. 5 is a block diagram illustrating a scenario in which multiple threads (SW1-SW9) of multiple applications are executed by a processor. Each of the threads SW1-SW9 is a software thread of a multi-threaded application 550 (e.g., APP1 and APP2). The processor may be the processor 100 of FIG. 1 or the processor 200 of FIG. 2. In this example, the processor provides a total of eight logical cores: four big logical cores (each shown as “big 520”) and four small logical cores (each shown as “small 530”). However, due to various constraints (e.g., thermal and power budget constraints), at any given time only four logical cores can run at the same time. Thus, only four logical cores are visible to the operating system 510. The operating system 510 (or more specifically, a scheduler) can schedule four software threads (each shown as “SW 540”) out of the total nine threads to run at the same time. The scheduling is made to maximize execution efficiency such that each of the nine threads is allocated a time slot to run and all of the nine threads appear to run at substantially the same time. However, at the hardware level, only four threads are concurrently executed. These four threads 540 may come from the same application 550 or from different applications 550. Moreover, at different time instances different sets of four threads 540 can be concurrently executed.

Regardless of which four threads 540 are scheduled to be concurrently executed, core selection circuitry 580 can match the characteristics of each thread with a logical core on which the thread is to be executed. The core selection circuitry 580 may be the core selection module 152 of FIG. 1, or execution circuitry within one of the physical cores that supports the logical core executing the core selection thread 252 of FIG. 2. As there are four threads running at the same time, a total of four logical cores are selected to be activated at any time. The selection is dynamic in that the four selected logical cores may change from time to time, depending on which threads are running, the type of operations being performed, current performance counter values, power budget and other operating considerations. For example, at a first time slot a first set 560 of two big logical cores 520 and two small logical cores 530 are selected, and at a second time slot a second set 570 of four small logical cores 520 are selected. The core selection circuitry 580 also determines whether the two big logical cores 520 in the first set 560 should be on the same big core or on two different big cores. Thus, the core selection also determines how many physical cores should be active. The core selection is transparent to the operating system 510. To the operating system 510, a total of four cores are available at any given time. The specifics about logical cores vs. physical cores, as well as which four logical cores are available and selected, are transparent to the operating system 510.

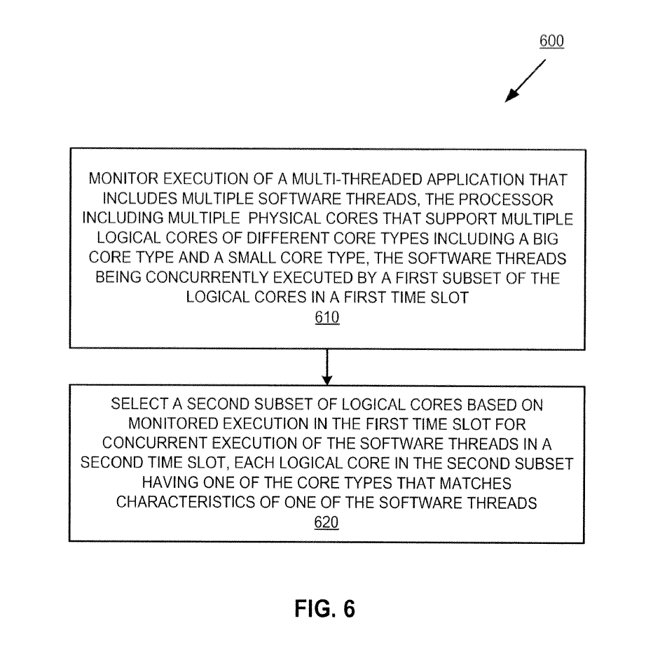

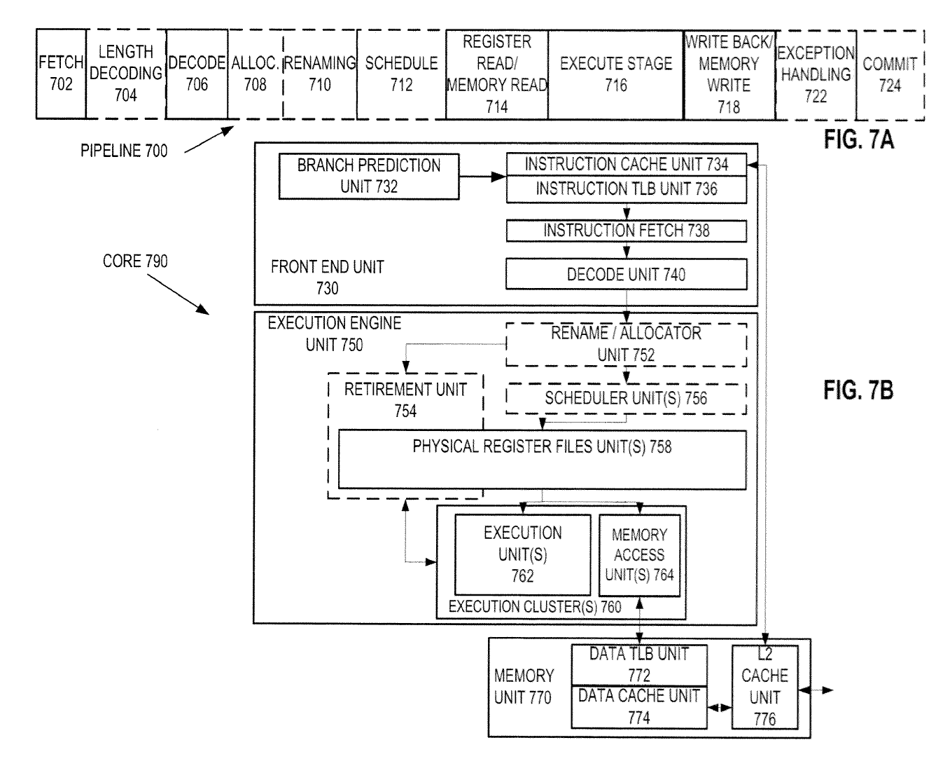

FIG. 6 is a flow diagram of an example embodiment of a method 600 for selecting logical cores according to one embodiment. In various embodiments, the method 600 of FIG. 6 may be performed by a general-purpose processor, a special-purpose processor (e.g., a graphics processor or a digital signal processor), or another type of digital logic device or instruction processing apparatus. In some embodiments, the method 600 of FIG. 6 may be performed by a processor, apparatus, or system, such as the embodiments shown in FIGS. 7A-B, 8A-B and 9-13. Moreover, the processor, apparatus, or system shown in FIGS. 7A-B, 8A-B and 9-13 may perform embodiments of operations and methods either the same as, similar to, or different than those of the method 600 of FIG. 6.

The method 600 begins when a processor (e.g., the processor 100 of FIG. 1 or the processor 200 of FIG. 2; or more specifically, the core selection circuitry 580 of FIG. 5) monitors execution of a multi-threaded application that includes multiple software threads (610). The processor includes multiple physical cores that support multiple logical cores of different core types, where the core types include a big core type and a small core type. The software threads are concurrently executed by a first subset of logical cores in a first time slot. Based on data gathered from monitored execution in the first time slot, the processor selects a second subset of logical cores for concurrent execution of the software threads in the second time slot (620). Each logical core in the second subset has a core type that matches the characteristics of one of the software threads.

Exemplary Core Architectures

In-Order and Out-of-Order Core Block Diagram

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., SSE, AVX1, AVX2, etc.), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary In-Order Core Architecture

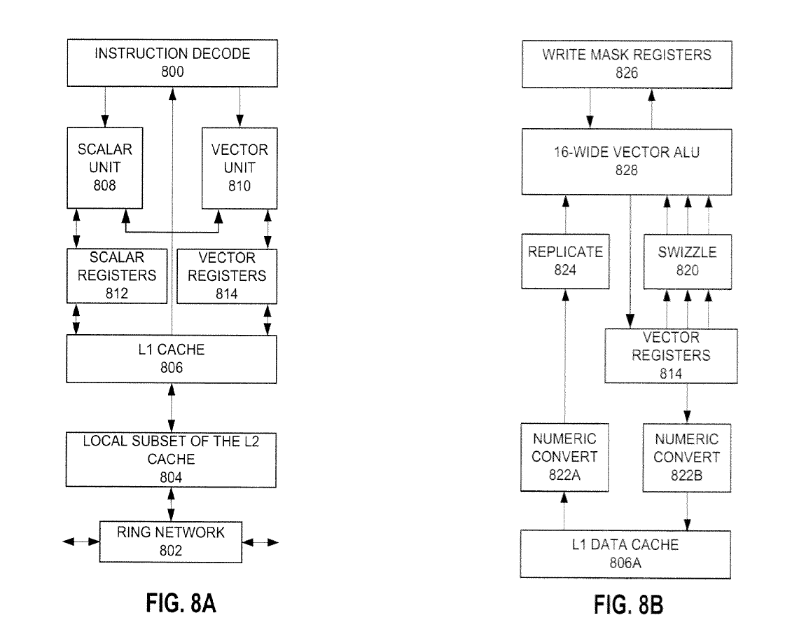

FIGS. 8A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 8A is a block diagram of a single processor core, along with its connection to the on-die interconnect network 802 and with its local subset of the Level 2 (L2) cache 804, according to embodiments of the invention. In one embodiment, an instruction decoder 800 supports the x86 instruction set with a packed data instruction set extension. An L1 cache 806 allows low-latency accesses to cache memory into the scalar and vector units. While in one embodiment (to simplify the design), a scalar unit 808 and a vector unit 810 use separate register sets (respectively, scalar registers 812 and vector registers 814) and data transferred between them is written to memory and then read back in from a level 1 (L1) cache 806, alternative embodiments of the invention may use a different approach (e.g., use a single register set or include a communication path that allow data to be transferred between the two register files without being written and read back).

The local subset of the L2 cache 804 is part of a global L2 cache that is divided into separate local subsets, one per processor core. Each processor core has a direct access path to its own local subset of the L2 cache 804. Data read by a processor core is stored in its L2 cache subset 804 and can be accessed quickly, in parallel with other processor cores accessing their own local L2 cache subsets. Data written by a processor core is stored in its own L2 cache subset 804 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 8B is an expanded view of part of the processor core in FIG. 8A according to embodiments of the invention. FIG. 8B includes an L1 data cache 806A part of the L1 cache 804, as well as more detail regarding the vector unit 810 and the vector registers 814. Specifically, the vector unit 810 is a 16-wide vector processing unit (VPU) (see the 16-wide ALU 828), which executes one or more of integer, single-precision float, and double-precision float instructions. The VPU supports swizzling the register inputs with swizzle unit 820, numeric conversion with numeric convert units 822A-B, and replication with replication unit 824 on the memory input. Write mask registers 826 allow predicating resulting vector writes.

Processor with Integrated Memory Controller and Graphics

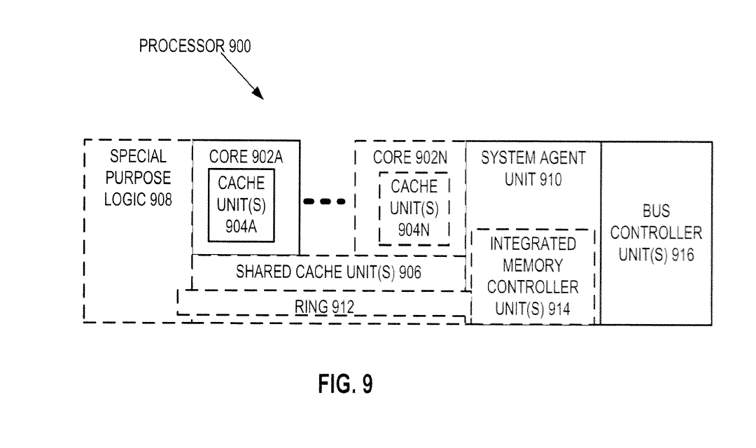

FIG. 9 is a block diagram of a processor 900 that may have more than one core, may have an integrated memory controller, and may have integrated graphics according to embodiments of the invention. The solid lined boxes in FIG. 9 illustrate a processor 900 with a single core 902A, a system agent 910, a set of one or more bus controller units 916, while the optional addition of the dashed lined boxes illustrates an alternative processor 900 with multiple cores 902A-N, a set of one or more integrated memory controller unit(s) 914 in the system agent unit 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof. While in one embodiment a ring based interconnect unit 912 interconnects the integrated graphics logic 908, the set of shared cache units 906, and the system agent unit 910/integrated memory controller unit(s) 914, alternative embodiments may use any number of well-known techniques for interconnecting such units. In one embodiment, coherency is maintained between one or more cache units 906 and cores 902-A-N.

In some embodiments, one or more of the cores 902A-N are capable of multi-threading. The system agent 910 includes those components coordinating and operating cores 902A-N. The system agent unit 910 may include for example a power control unit (PCU) and a display unit. The PCU may be or include logic and components needed for regulating the power state of the cores 902A-N and the integrated graphics logic 908. The display unit is for driving one or more externally connected displays.

The cores 902A-N may be homogenous or heterogeneous in terms of architecture instruction set; that is, two or more of the cores 902A-N may be capable of execution the same instruction set, while others may be capable of executing only a subset of that instruction set or a different instruction set.

Exemplary Computer Architectures

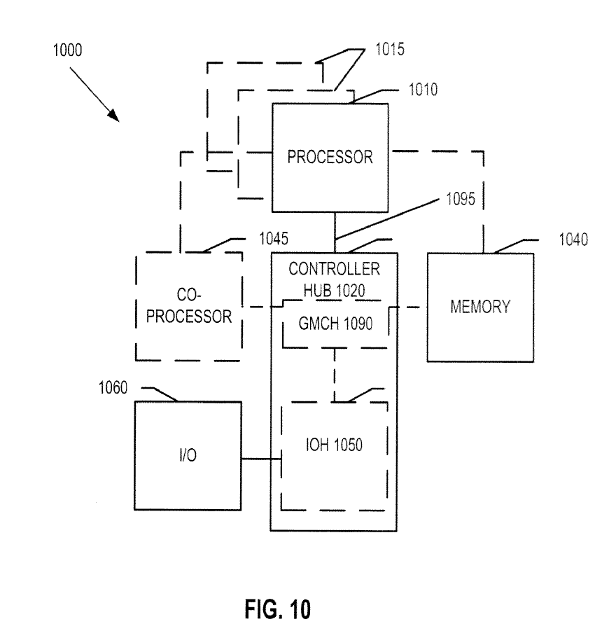

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1000 in accordance with one embodiment of the present invention. The system 1000 may include one or more processors 1010, 1015, which are coupled to a controller hub 1020. In one embodiment the controller hub 1020 includes a graphics memory controller hub (GMCH) 1090 and an Input/Output Hub (IOH) 1050 (which may be on separate chips); the GMCH 1090 includes memory and graphics controllers to which are coupled memory 1040 and a coprocessor 1045; the IOH 1050 is couples input/output (I/O) devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 in a single chip with the IOH 1050.

The optional nature of additional processors 1015 is denoted in FIG. 10 with broken lines. Each processor 1010, 1015 may include one or more of the processing cores described herein and may be some version of the processor 900.

The memory 1040 may be, for example, dynamic random access memory (DRAM), phase change memory (PCM), or a combination of the two. For at least one embodiment, the controller hub 1020 communicates with the processor(s) 1010, 1015 via a multi-drop bus, such as a frontside bus (FSB), point-to-point interface such as QuickPath Interconnect (QPI), or similar connection 1095.

In one embodiment, the coprocessor 1045 is a special-purpose processor, such as, for example, a high-throughput MIC processor, a network or communication processor, compression engine, graphics processor, GPGPU, embedded processor, or the like. In one embodiment, controller hub 1020 may include an integrated graphics accelerator.

There can be a variety of differences between the physical resources 1010, 1015 in terms of a spectrum of metrics of merit including architectural, micro-architectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

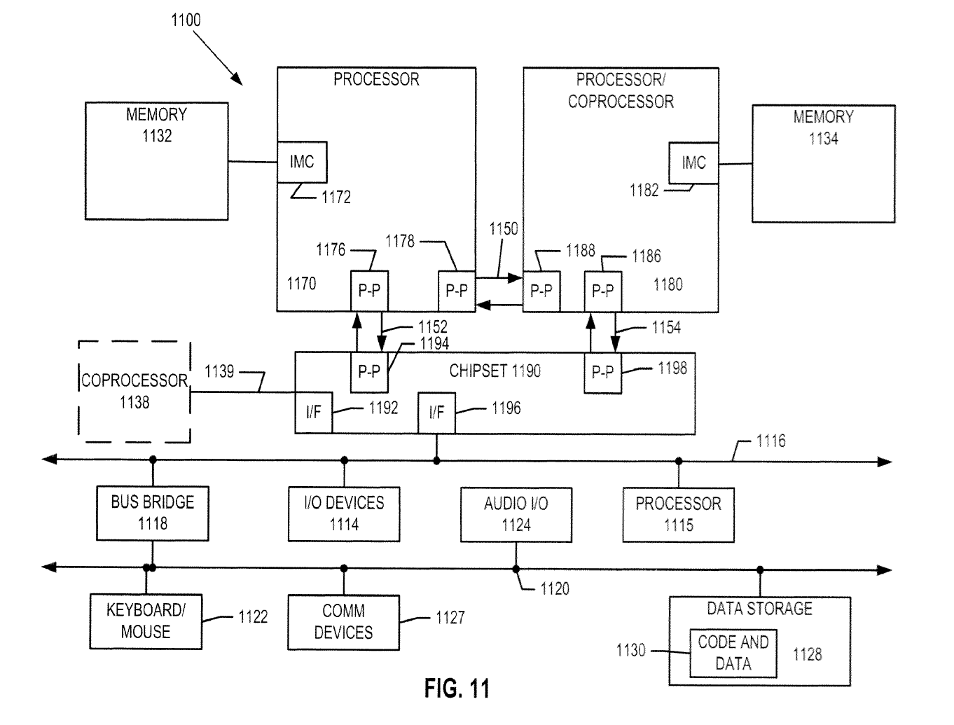

Referring now to FIG. 11, shown is a block diagram of a first more specific exemplary system 1100 in accordance with an embodiment of the present invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In one embodiment of the invention, processors 1170 and 1180 are respectively processors 1010 and 1015, while coprocessor 1138 is coprocessor 1045. In another embodiment, processors 1170 and 1180 are respectively processor 1010 coprocessor 1045.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1139. In one embodiment, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present invention is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1120. Note that other architectures are possible. For example, instead of the point-to-point architecture of FIG. 11, a system may implement a multi-drop bus or other such architecture.

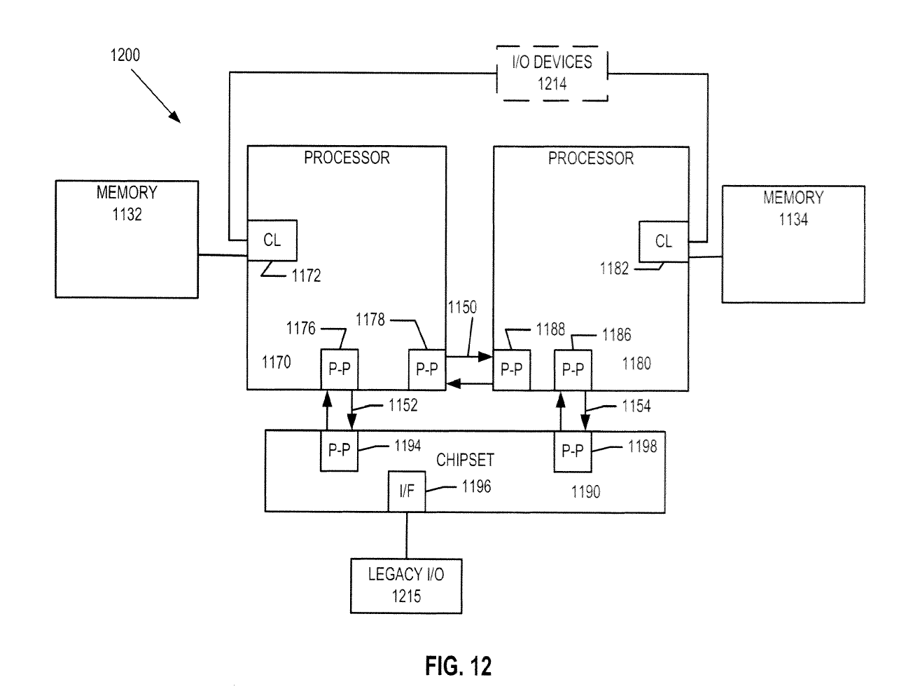

Referring now to FIG. 12, shown is a block diagram of a second more specific exemplary system 1200 in accordance with an embodiment of the present invention. Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1172 and 1182, respectively. Thus, the CL 1172, 1182 include integrated memory controller units and include I/O control logic. FIG. 12 illustrates that not only are the memories 1132, 1134 coupled to the CL 1172, 1182, but also that I/O devices 1214 are also coupled to the control logic 1172, 1182. Legacy I/O devices 1215 are coupled to the chipset 1190.

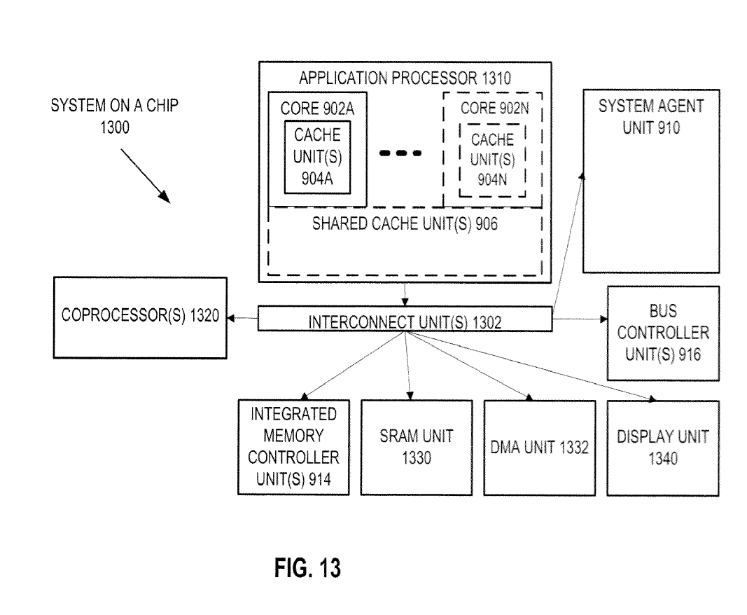

Referring now to FIG. 13, shown is a block diagram of a SoC 1300 in accordance with an embodiment of the present invention. Similar elements in FIG. 9 bear like reference numerals. Also, dashed lined boxes are optional features on more advanced SoCs. In FIG. 13, an interconnect unit(s) 1302 is coupled to: an application processor 1310 which includes a set of one or more cores 902A-N and shared cache unit(s) 906; a system agent unit 910; a bus controller unit(s) 916; an integrated memory controller unit(s) 914; a set or one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising:
a plurality of physical cores to execute a multi-threaded application that includes a plurality of software threads, wherein the physical cores support a plurality of logical cores of different core types including a big core type and a small core type, and the software threads are to be concurrently executed by a first subset of the logical cores in a first time slot; and
core selection circuitry coupled to the physical cores, the core selection circuitry operative to monitor execution of the software threads, and to select a second subset of the logical cores based on monitored execution in the first time slot for concurrent execution of the software threads in a second time slot, wherein each logical core in the second subset has one of the core types that matches characteristics of one of the software threads.

2. The apparatus of claim 1, further comprising a first set of performance counters located within the physical cores and a second set of performance counters located outside the physical cores in the processor, wherein the core selection circuitry is operative to monitor the first set of performance counters and the second set of performance counters to determine the characteristics of the software threads.

3. The apparatus of claim 2, wherein the first set and the second set of performance counters include one or more of the following: memory load counters, cache miss counters, translation lookaside buffer (TLB) miss counters, branch miss prediction counters, and stall counters.

4. The apparatus of claim 1, wherein a first one of the logical cores having the big core type has more processing power and consumes more power than a second one of the logical cores having the small core type.

5. The apparatus of claim 1, wherein the core selection circuitry is located within a power control unit.

6. The apparatus of claim 1, wherein the core selection circuitry is execution circuitry within one of the physical cores that executes a core selection thread.

7. The apparatus of claim 1, wherein the first set of the logical cores are supported by a first number of the physical cores and the second set of the logical cores are supported by a second number of the physical cores, and wherein the first number is different from the second number.

8. The apparatus of claim 1, wherein selecting the second subset of the logical cores further comprises:
selecting one of the core types for each of the software threads to provide an optimal performance per watt within a power budget of the processor.

9. A method comprising:
monitoring, by a processor, execution of a multi-threaded application that includes a plurality of software threads, the processor including a plurality of physical cores that support a plurality of logical cores of different core types including a big core type and a small core type, the software threads being concurrently executed by a first subset of the logical cores in a first time slot; and
selecting a second subset of the logical cores based on monitored execution in the first time slot for concurrent execution of the software threads in a second time slot, each logical core in the second subset having one of the core types that matches characteristics of one of the software threads.

10. The method of claim 9, wherein monitoring the operations further comprises:
monitoring performance counters in the processor to determine the characteristics of the software threads, a first set of the performance counters located within the physical cores and a second set of the performance counters located outside the physical cores.

11. The method of claim 9, wherein a first one of the logical cores having the big core type has more processing power and consumes more power than a second one of the logical cores having the small core type.

12. The method of claim 9, wherein the first set of the logical cores are supported by a first number of the physical cores and the second set of the logical cores are supported by a second number of the physical cores, and wherein the first number is different from the second number.

13. The method of claim 9, further comprising:
detecting a computational bottleneck during execution of a first one of the software threads that is executed by a logical core of the small core type; and
selecting another logical core of the big core type to continue execution of the first software thread.

14. The method of claim 9, further comprising:
detecting that the software threads perform a same operation on different data sets in the first time slot; and
selecting logical cores of a same core type for executing the software threads in the second time slot.

15. The method of claim 9, wherein selecting the second subset of the logical cores further comprises:
selecting one of the core types for each of the software threads to provide an optimal performance per watt within a power budget.

16. A system comprising:
memory; and
a processor coupled to the memory, the processor comprising:
a plurality of physical cores to execute a multi-threaded application that includes a plurality of software threads, wherein the physical cores support a plurality of logical cores of different core types including a big core type and a small core type, and the software threads are to be concurrently executed by a first subset of the logical cores in a first time slot; and
core selection circuitry coupled to the physical cores, the core selection circuitry operative to monitor execution of the software threads, and to select a second subset of the logical cores based on monitored execution in the first time slot for concurrent execution of the software threads in a second time slot, wherein each logical core in the second subset has one of the core types that matches characteristics of one of the software threads.

17. The system of claim 16, further comprising a first set of performance counters located within the physical cores and a second set of performance counters located outside the physical cores in the processor, wherein the core selection circuitry is operative to monitor the first set of performance counters and the second set of performance counters to determine the characteristics of the software threads.

18. The system of claim 16, wherein the first set and the second set of performance counters include one or more of the following: memory load counters, cache miss counters, translation lookaside buffer (TLB) miss counters, branch miss prediction counters, and stall counters.

19. The system of claim 16, wherein the core selection circuitry is located within a power control unit.

20. The system of claim 16, wherein the core selection circuitry is execution circuitry of one of the physical cores that executes a core selection thread.
